(19) United States
(12) Patent Application Publication
(10) Pub. No.: US 2014/0150959 A1
(43) Pub. Date: Jun. 5, 2014

(54) METHOD AND APPARATUS FOR FIXING RIGID DECORATIVE ELEMENTS ON A SUBSTRATE, AND CARRIER STRIP WITH DECORATIVE ELEMENTS

(71) Applicant: Roland F. Gratzer, Wien (AT)

(72) Inventor: Roland F. Gratzer, Wien (AT)

(73) Assignee: GRATZER! TECHNOLOGIES GMBH & CO. KG, WIEN (AT)

(21) Appl. No.: 14/233,998

(22) PCT Filed: Jul. 10, 2012
(86) PCT No.: PCT/EP2012/002905

§ 371 Date: Jan. 21, 2014

Related U.S. Application Data
(60) Provisional application No. 61/534,607, filed on Sep. 14, 2011.

(30) Foreign Application Priority Data
Jul. 19, 2011 (EP) 11005922.7

(51) Int. Cl. B44C 3/12; B65D 83/04

(52) U.S. Cl. CPC B44C 3/12; B65D 83/0409
USPC 156/230; 221/268; 221/274; 221/1; 206/486

(57) ABSTRACT

An apparatus for transferring decorative rigid bodies from a carrier strip onto a substrate includes a reciprocator adapted for individually bringing the decorative rigid bodies into contact with the substrate, and a tractor mechanism operatively coupled to the reciprocator such that an outward motion of the reciprocator is registered with transportation of the carrier strip such that one of the decorative rigid bodies is brought between the reciprocator and the substrate. The carrier strip has pockets accommodating decorative rigid bodies, and right and left side rims, the right and/or left side rims having engagement features adapted to receive one or more bosses of the tractor mechanism of the apparatus. A method is performed for transferring the decorative rigid bodies from the carrier strip onto the substrate.

### CROSS-REFERENCE TO RELATED APPLICATIONS

The present application claims priority of Provisional Patent Application No. 61/534,607, filed Sep. 14, 2011 in the U.S.A., entitled “A Transfer Strip for Accommodating Rigid Decorative Bodies to be Transferred Onto a Substrate”, the contents of which are hereby incorporated by reference in their entirety as if set forth in full. The present application further claims priority of European Patent Application No. 11 005 922.7, filed Jul. 19, 2011 in Europe, entitled “Transfer Strip Including an Array of Decorative Rigid Bodies, Cartridge Containing the Transfer Strip, Apparatus For Transferring Decorative Rigid Bodies, and Method of Fixing Decorative Elements to a Substrate.” The present application further claims the benefit of European Patent Application No. 12 001 604.3, filed Mar. 8, 2012 in Europe, entitled “Arrangement and Method for Applying Decorative Rigid Bodies to a Substrate”, the contents of both of which are hereby incorporated by reference in their entirety as if set forth in full.

### FIELD

The invention relates to a method and an apparatus for transferring decorative elements onto a substrate, and to a carrier strip carrying such decorative elements.

### BACKGROUND

Decorative patterns are usually transferred from a carrier sheet onto a substrate to be decorated. The technique is generally limited to flexible decorative sheets. For such sheets, it may be cumbersome to properly arrange the carrier sheet on the substrate.

A magazine strip for gems has become known from U.S. Pat. No. 5,252,377. The magazine strip has a sandwich structure, comprising in particular a middle soft layer, a reversibly deformable layer disposed thereabove and optionally a reversibly deformable layer disposed under the middle layer. The magazine strip has at least in its upper layer holes into which the gems can be pressed and out of which they can be individually pressed with equal ease. It has turned out that this magazine strip is not sufficiently reliable for automated or semi-automated processes.

It would be desirable to have available more reliable means for decorating a substrate with rigid decorative elements. In particular, it would be desirable to have available a ribbon-like material, with which rigid decorative elements can readily and reliably be applied to a substrate by an automated or semi-automated process. It would also be desirable to have available an apparatus for transferring rigid decorative elements from the ribbon-like material onto the substrate.

### SUMMARY

Embodiments relate to an apparatus for transferring decorative rigid bodies each having at least one flat side from a carrier strip carrying the decorative rigid bodies onto a substrate. The apparatus comprises a reciprocator, adapted for individually bringing the decorative rigid bodies into contact with the substrate at a transfer position by substantially linear movement of the reciprocator, and means coupling a strip transporter to the movement of the reciprocator. “Substantially linear movement” is to be interpreted in a way that an exclusively rotational movement of the reciprocator is excluded. Thus, movement of the reciprocator must have a linear component or be purely linear and thus run along a straight line. The reciprocator may be a linear reciprocator such as a hammer or a plunger, for example. Furthermore, with respect to the decorative rigid bodies “flat side” may refer either to a plane side and/or a sphere having a radius of curvature of more than 30 cm and especially more than 60 cm, and/or a side fitting into a spherical surface having a radius of curvature of more than 30 cm and especially more than 60 cm.

According to an embodiment the apparatus comprises a reciprocator, which is mounted in reciprocatable manner so that an outward motion of the reciprocator is registered with transportation of the carrier strip such that the next of the decorative rigid bodies on the carrier strip comes into the transfer position, and the reciprocator is arranged to exert a force onto the carrier strip such that the flat side of at least one of the decorative rigid bodies is protruded from the apparatus, and optionally comprises an actuator for the reciprocator.

According to an embodiment the reciprocator is mounted on or in a casing, and the casing is movable in reciprocating manner in a protrusion direction of the at least one of the decorative rigid bodies.

According to an embodiment the reciprocator is resiliently mounted on and/or in the casing, wherein a gear synchronizes the translational motion of the reciprocator with respect to the casing into a forwarding motion of the carrier strip.

According to an embodiment the gear includes a one-sided lever and/or a tractor mechanism engaging the carrier strip, wherein the lever engages on its one part with the reciprocator and on its other part with the tractor mechanism such that the motion of the reciprocator causes an alternate engaging and disengaging of the tractor mechanism with the carrier strip.

According to an embodiment the tractor mechanism includes a protrusion for engagement with the carrier strip. According to an embodiment the protrusion has a wedged shape. According to an embodiment a pair of protrusions are formed, for engaging the carrier strip on both its side rims.

According to an embodiment the tractor mechanism engages the carrier strip at a position downstream of the transfer position. In other terms the tractor mechanism is arranged to pull the next decorative rigid body on the carrier strip into the transfer position. The term “downstream” as used in the present application is measured along a length dimension of the carrier strip when the carrier strip is mounted in the apparatus.

According to an embodiment the casing has a stop extending from the apparatus in the protrusion direction, the stop being arranged for blocking the movement of the casing upon contact with the substrate, such that the movement of the reciprocator continues, resulting in a relative movement of the reciprocator and the casing. Thus, the casing may be moved by moving the reciprocator and movement of the casing is stopped as soon as the stop comes into contact with the substrate.

According to an embodiment the stop may consist of one or more, e.g. three knobs in the vicinity of the transfer position, defining a mathematical contact plane for the substrate. In this case, linear movement of the reciprocator may include an angle of between 60° and 120° and especially 80° and 100° and further especially 90° with respect to the mathematical contact plane.

According to an embodiment the actuator includes a bushing mounted eccentrically to the reciprocator.

According to an embodiment the bushing surrounds the part of the carrier strip from which the decorative rigid bodies have been transferred to the substrate at least in a section downstream of the transfer position.

According to an embodiment the apparatus comprises a downstream guide located adjacent the transfer position for guiding the carrier strip upwards, i.e. away from the substrate after the decorative rigid bodies have been transferred.

According to an aspect, a carrier strip carrying an array of decorative elements is provided, wherein the carrier strip has a top layer and a pouch layer having through-holes within which the decorative element are accommodated. The through-holes are sufficiently wide that the decorative elements can be pressed out of the pouches by the exertion of a force on the top layer. The decorative elements have flat outward sides to which an adhesive may be applied. If so, the outward flat sides, when coming into contact with the substrate, adhere to the latter according to another respect. It is also possible to provide the decorative elements with an adhesive on the opposite flat side, to transfer the decorative elements individually onto a tacky transfer sheet in a pattern which is a mirror image of the desired target pattern, to turn the tacky transfer sheet around with the decorative elements adhering to it, to then place the transfer sheet onto the target substrate with the decorative elements facing the substrate, such that the adhesive on the decorative elements contacts the substrate, and to adhere the decorative elements to the substrate.

The decorative elements provided on the carrier strip can readily be adhered on a substrate by exerting pressure on the back side of the carrier strip either manually, or using the apparatus, so that the flat sides of the elements bearing an adhesive come into contact with the substrate. It is thereby readily possible to arrange the decorative elements in regular one-, two- or even three-dimensional patterns. It is also possible to arrange the decorative elements in rectangular, quadratic or polygonal patterns. As an example, the elements may surround a framed photograph.

The carrier (or transfer) strip, or tape, generally comprises three parts, namely a top layer, a pouch layer with apertures, and the decorative elements to be transferred. The elements are positioned in the apertures or through holes of the pouch layer, so that they are laterally surrounded by the same. The top layer is adhered or welded onto the pouch layer and the decorative elements are held in place by the combined action of both layers until transfer is executed. The pouch layer not only protects the decorative elements laterally, but also provides enhanced stability of the entire carrier strip.

In one embodiment, the pouch layer is slightly thicker than the decorative elements accommodated in its apertures. Accordingly, the decorative elements may have an adhesive applied on their flat bottom faces, without their sticking to any flat substrates. The carrier strip may even be wound into a coil, without the decorative elements' bottom sides contacting the top side of the adjacent top layer and adhering thereto. In an alternative embodiment, the pouches have a height (i.e., extension perpendicular to the strip plane) which is less than the thickness of the decorative elements, so that one flat face of the decorative elements protrudes from the through holes formed in the pouches.

In one embodiment, the decorative elements may have a planar-convex shape providing a small contact area on their convex top portion facing towards the top layer, and a larger planar bottom portion facing, in use, towards the substrate.

The carrier strip may further include registration notches arranged at the same pitch as the decorative elements, an integer multiple thereof, or at least a commensurate pitch. When such registration notches are present, it is desirable if they are located sufficiently far removed towards the rims of the strip that their lengthwise projection does not overlap that of the apertures in the spacer layer housing the decorative elements. In one embodiment, the notches are formed in one or both of the side rims. In one embodiment, the notches have a general U-shape. This is because the straight part of the “U” is particularly suitable for engaging with a tractor mechanism of a transfer apparatus, and the round part of the “U” inhibits breaking of the carrier strip at the end of the straight part.

The appended drawings show:

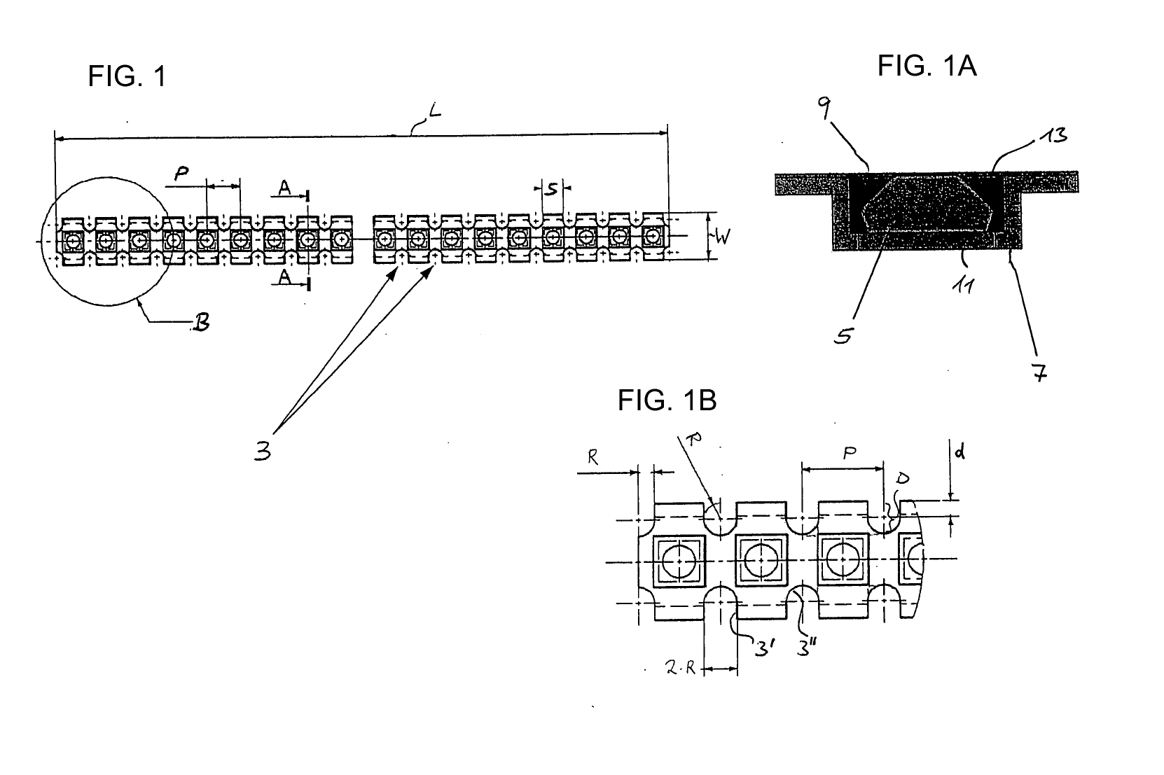

FIG. 1, 1a, 1b a two-layer transfer strip with square pockets for crystals, as a full view, cross section, and close-up;

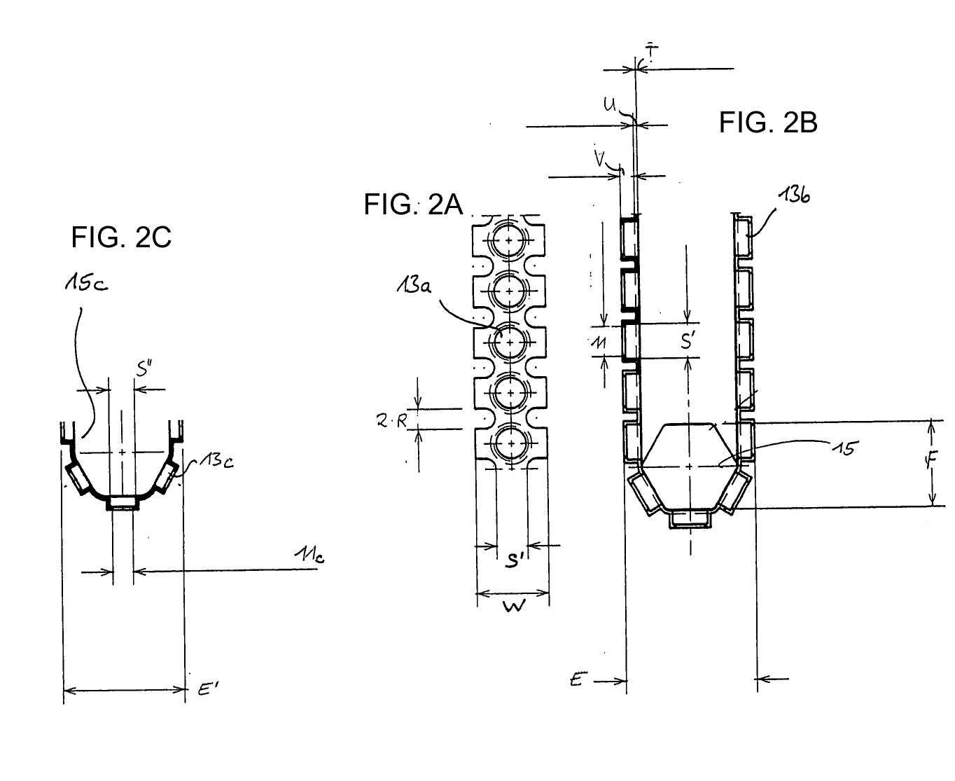

FIGS. 2a and 2b another transfer strip with round pockets arranged on a hexagonal transfer reel;

FIG. 2c a similar transfer strip arranged on an octagonal transfer reel; strip of FIG. 2a;

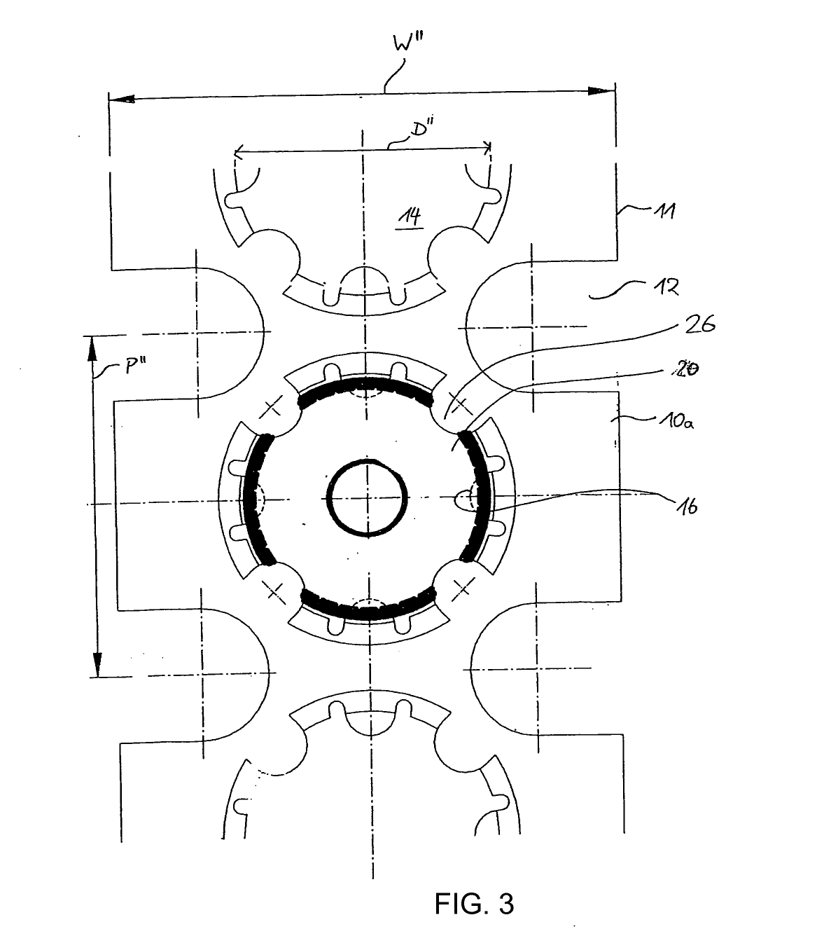

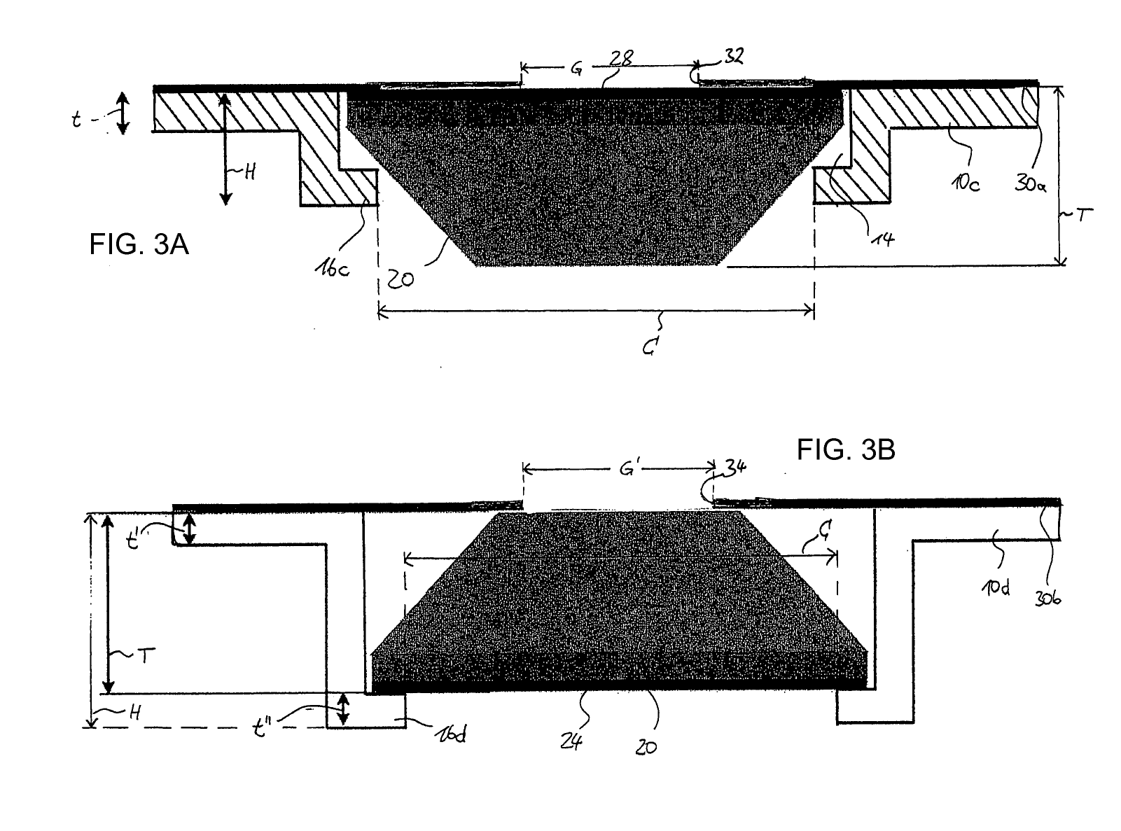

FIGS. 3a and 3b show cross-sectional views of two variants of transfer strips with non-contiguous top layers and different crystal mountings;

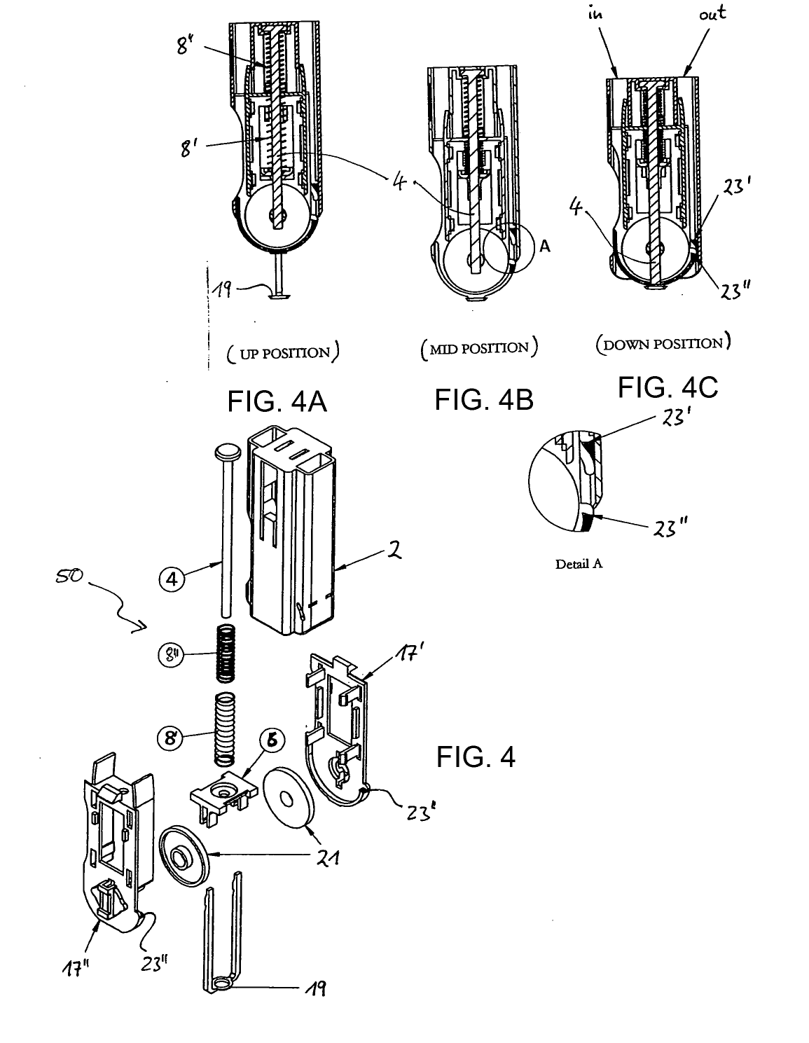

FIG. 4 shows a device for manually applying crystals onto a substrate, comprising a linearly reciprocating tractor mechanism;

FIGS. 4a-c show sequential relative positions of the parts shows in FIG. 4;

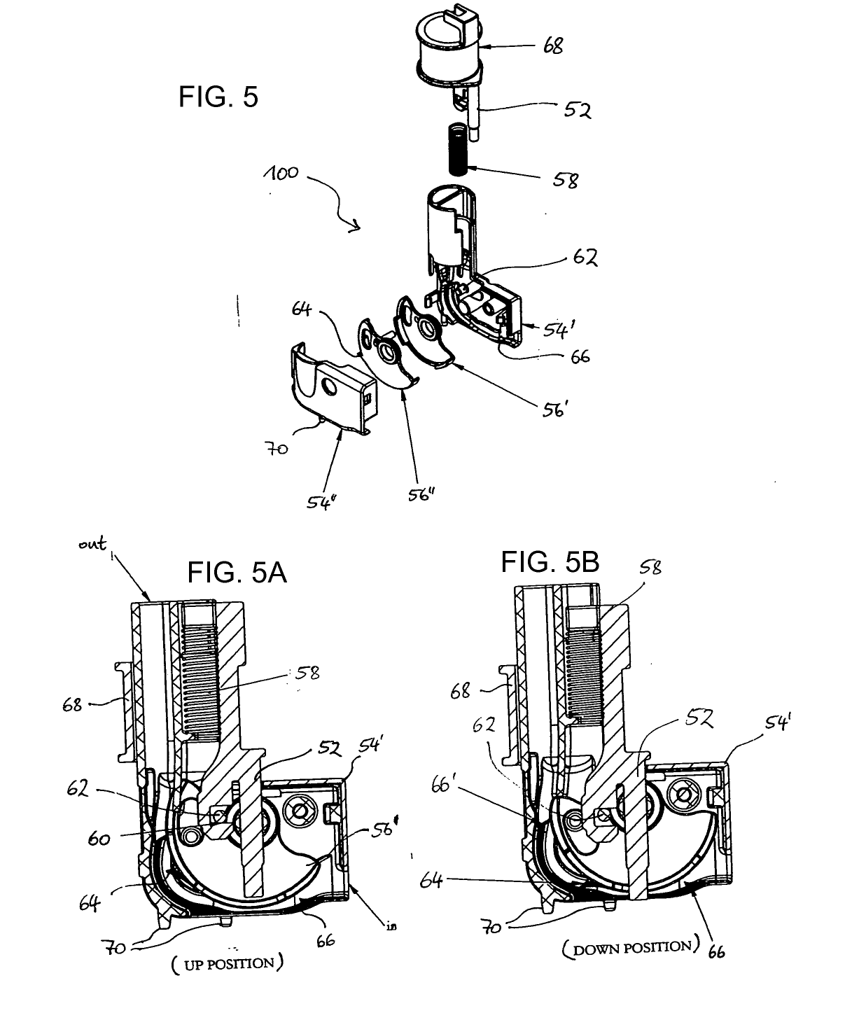

FIG. 5 shows a device for automatically applying crystals onto a substrate, comprising a partcircularly reciprocating tractor mechanism;

FIGS. 5a-b show sequential relative positions of the parts shows in FIG. 5;

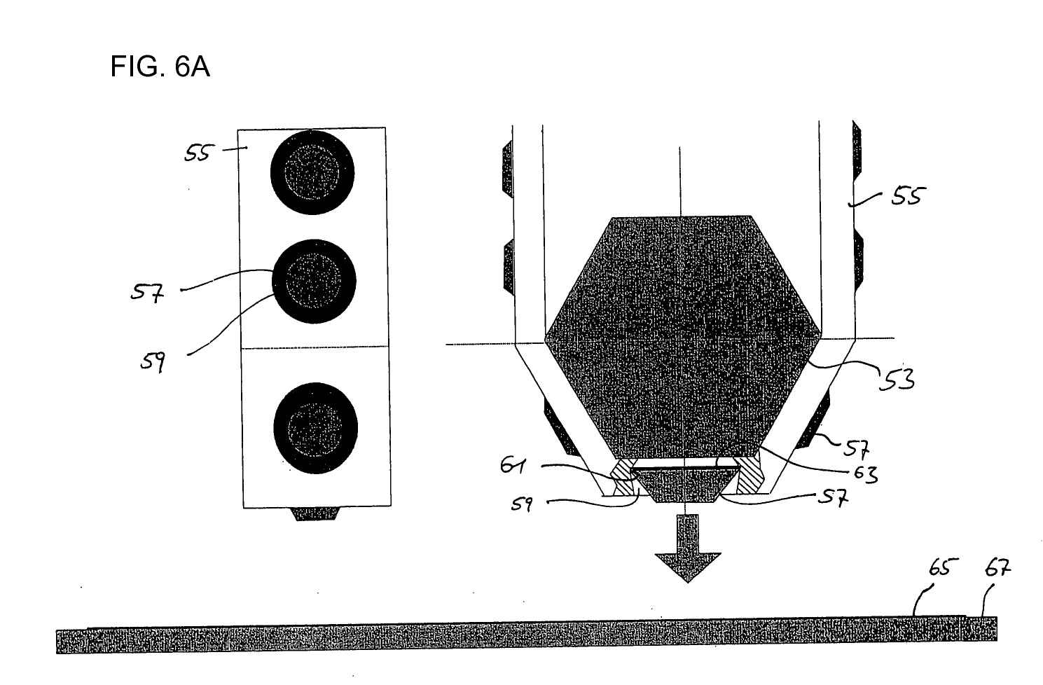

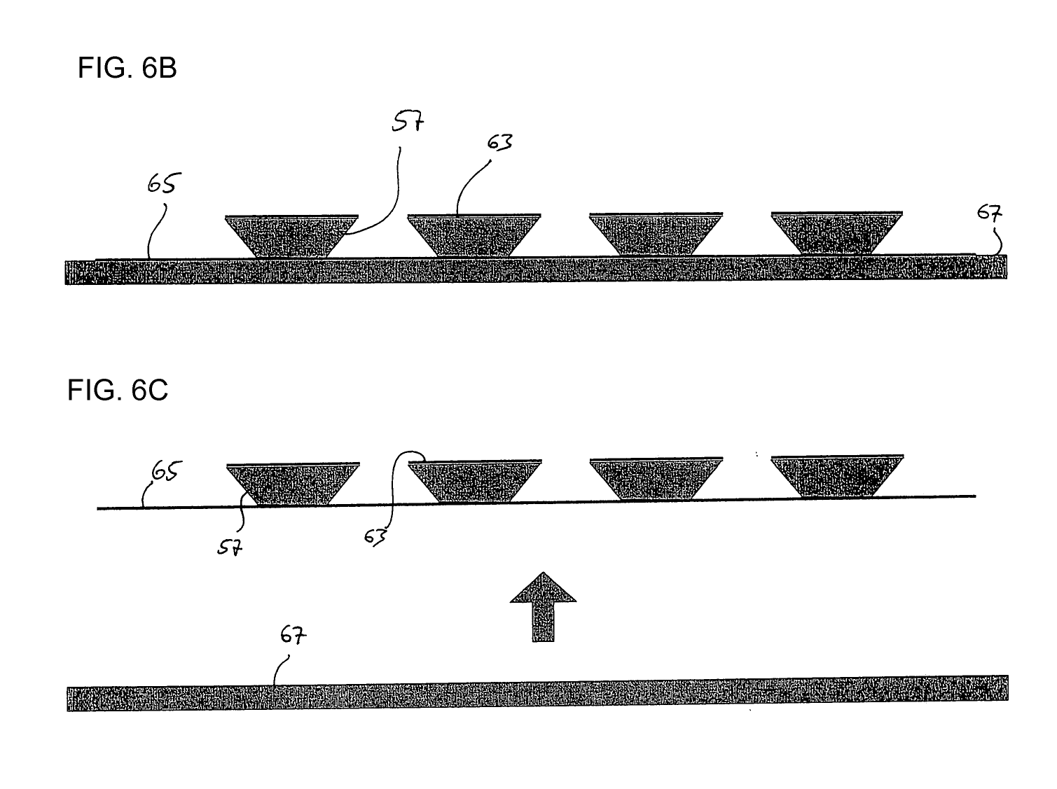

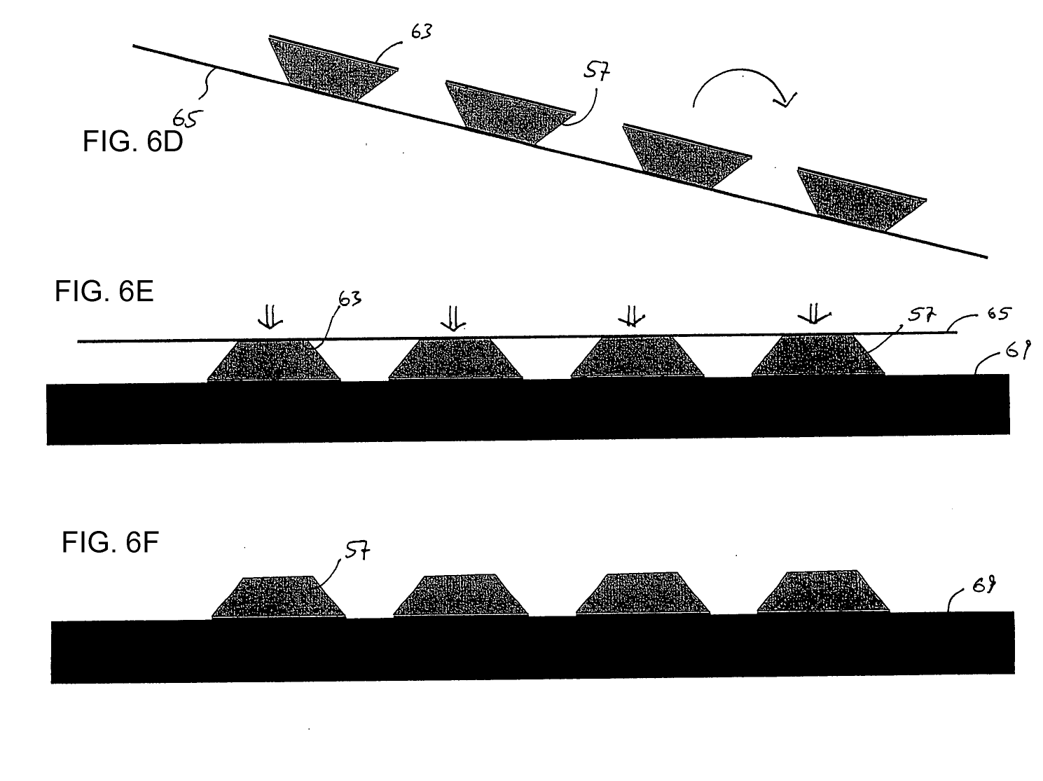

FIGS. 6a to 6f an operation mode using an intermediate sheet, thereby inverting the pattern; and

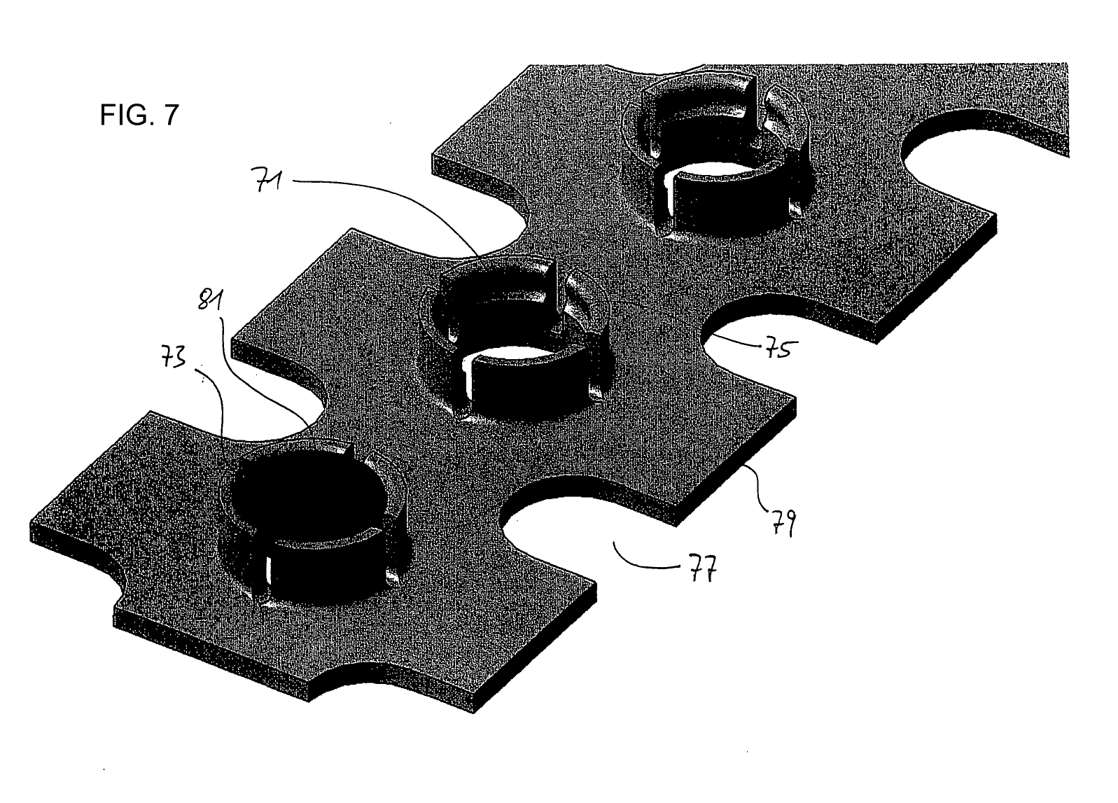

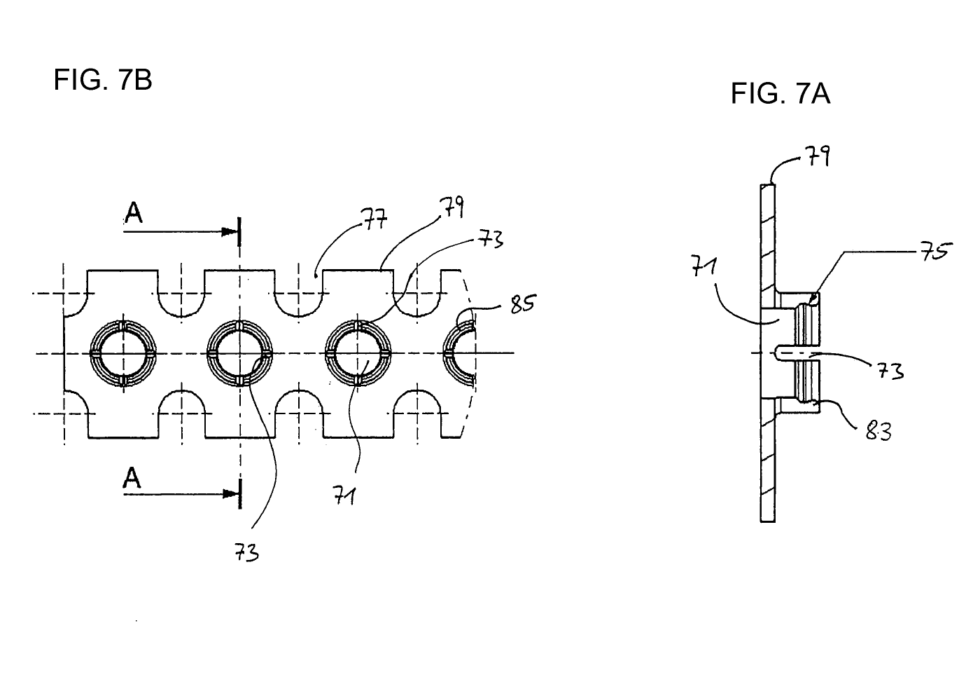

FIGS. 7, 7a, 7b another transfer strip having only one layer and an annular groove or rim.

FIG. 1 shows a transfer (or carrier) strip (or tape) of 4 mm pitch P and 440 mm full length L, 5.7 mm full width W, and 2.5 mm pocket size S. The strip has rows of transport notches 3 along both its opposing side edges. As may be seen in FIG. 1b, the notches 3 have an outer straight section 3′ of length d and an inner hemicircular section 3″. The radius R of the hemi-circular section is 0.8 mm in this embodiment, and the full width 2.R of the notches accordingly 1.6 mm, which equals also their depth D. As shown in Figure la, the crystals 5 are accommodated in the pockets 13 formed by a corrugated layer 7, and adhered to a thin top layer 9. The corrugated layer 7 has openings 11 at the positions of the crystals 5. The top layer 9 may be adhered to the crystals 5 by an easily releasable adhesive. In operation, the crystals are expelled through the openings 11 by the action of a force onto the crystals 5 through the top layer 9.

FIG. 2a shows another transfer tape with generally similar dimensions, but with circular pockets 13a. According to

FIG. 2b, which shows still another transfer strip arranged in a loop around a hexagonal-prismatic transfer reel 15, such round pockets 13b can have a somewhat larger size S′ such as 2.8 mm without compromising overall stability of the tape. Note that in principle, the transfer reel 15 may also be pentagonal, or octagonal, with an accordingly smaller or larger diameter F. The full width E of the supply arrangement will also depend on the type of wheel 15. As shown in FIG. 2c, an octagonal wheel leads to slightly smaller pockets (or pouches) 13c in order that the transfer reel 15c retains a similarly small overall size, necessitating smaller apertures 11c as well.

In another embodiment according to FIG. 3, a transfer strip has four lower tabs 16 (indicated by dashed lines in this top view) and four upper tabs 26 for holding the crystals in place. Each set of four tabs is arranged at equidistant spacings around a respective circumference of the opening 14. A pitch P″ of the transfer strip is about one third larger than a largest diameter D″ of the openings 14. Similar notches 12 formed in both side rims 11 as in Figure la are present in this transfer strip 10a, the full width W″ of which remains also about the same.

The force needed to protrude the crystals from the openings 14 can readily be adjusted by selecting the number and width (and length) of the tabs (or the notches between same). Further, the exact positions at which the crystals are held are selectable to some extent by choosing the depths to which the walls of the openings are cut out for forming the tabs: The deeper the cuts, the more flexible the tabs will be. In this manner, the cutting of the tabs may to some extent account for potentially varying sizes of the crystals. Also, the notches generally reduce the force required to force the crystals out from the through holes. Usually, two oppositely spaced notches may suffice. Three or four notches in each periphery will be more typical, however.

In another embodiment shown only in cross section in FIGS. 3a and 3b, the entire transfer strip 10c or 10d, respectively, is covered with a top sheet 30a having e.g. a series of holes 32 or one contiguous hole or gap 34. This top sheet 30a is then heat-welded onto the transfer strip 10c such that the hole/s 32 of the top sheet 30a is/are in registration with the openings 14 of the transfer strip 10c. Thereby, the crystals 20 are likewise accommodated in the openings 14. Naturally, the clearance C in the rim 16c at the first end is smaller than the largest diameter of the crystal 20. This arrangement is useful particularly where the crystal has a layer of a heat-sensitive adhesive (melt adhesive) 28 on its larger, top face. The crystal's bottom face, which in this example protrudes from the first, bottom end, may be applied onto a tacky intermediate substrate. In the example shown, the thickness T of the crystal 20 is larger than the height H of the transfer strip 10c, so that the crystal 20 protrudes from the first end of the opening 14. A thickness t of the material of the transfers trip may be about 0.2 to 0.5 mm.

In another embodiment, the thickness T of the crystal 20 is less than the full height H of the transfer strip 10d, and is even slightly less than the full height H minus the thickness of the rim 16d at the first, bottom end, so that the crystal 20 is held loosely in the opening 14, no force is exerted on the rim 16d, and accordingly the adhesive 24 may not bond to the rim even if it is a pressure sensitive adhesive. According to a different embodiment, the contact is between the inner periphery of each through hole and the outer periphery of the crystals.

In this embodiment, the crystal 20 may also protrude through the central gap or hole 32, 34 in the top sheet, where the smallest diameter G, G′ of the gap or hole is larger than that of the top face of the crystal, and which gap or hole has oblong shape.

In the above embodiments, a suitable material for the transfer strip is polystyrene PS, although polypropylene PP and polyethyleneterephthalate PET are also possible.

Referring to FIGS. 4 and 4a-c, a manually operated device 50 for applying rigid bodies such as glass crystals onto a substrate will be explained: A piston 4 is mounted in an outer housing 2, and a transfer reel 21 consisting of two symmetrically arranged disks is mounted in an inner housing 17′, 17″. The inner and outer housings are biased against each other by means of a first, harder spring 8″. An aiming aid 19 is mounted between the inner housings 17′, 17″, and biased by a softer spring 8′ by means of an intercepting member 6. In operation, a carrier strip is guided by ducts of the outer housing 2 to the curved end part of the inner housing 17′, 17″. Transport of the carrier strip is accomplished by the combined action of a first tooth 23′ (or pair of teeth) arranged on the inner side of the outer housing 2 (“moving tooth”), and a second tooth 23″ (or pair of teeth) located on the inner side of the curved part of the inner housing 17′, 17″ (“blocking tooth”). In the idle state, the aiming aid 19 protrudes from the curved part. When the device is brought near a substrate, the aiming aid 19 first contacts the substrate, accurately indicating the position where the crystal will be applied to the substrate (FIG. 4a, “UP POSITION”). Further approaching the device to the substrate will compress the softer spring 8′ (FIG. 4b, “MID POSITION”). Still further approaching the device towards the substrate will also compress the harder spring 8″ (FIG. 4c, “DOWN POSITION”). In this last step, the piston 4 will be forced downward against the crystal sitting in the transfer position below the piston 4, and accordingly will be expelled from the carrier strip and adhered to the substrate. During the downward motion of the outer housing 2, the carrier strip will be blocked from moving by the blocking tooth 23″ (or pair of teeth as in the embodiment) on the curved part of the inner housing 17′, 17″. At the end of the last step, the moving tooth 23′ (or pair of teeth) will engage with a corresponding notch in the carrier strip (or pair of notches). When the device is next retracted from the substrate, the springs 8′, 8″ will push out the inner housing 17′, 17″ carrying the transfer wheel disks 21, thereby exerting a drag on the carrier strip. However, the moving tooth 23′ having engaged with the corresponding notch of the carrier strip, the required length of the carrier strip will be dragged in through the opposing duct (“in”) by one pitch and place the next crystal in the transfer position, thereby rotating the transfer wheel disks 21. In this process, the blocking tooth 23″ is disengaged from the carrier strip. Needless to say, the teeth suitably have wedged shapes to readily disengage and re-engage from the notches in the carrier strip. Finally, upon still further retraction, also the aiming aid 19 will be fully protruded from the inner housing 17′, 17″, and the cycle is completed.

Referring to FIGS. 5 and 5a-b, an automatically operated device 100 for applying rigid bodies such as glass crystals onto a substrate will be explained: A piston 52 is slidably mounted in a housing 54′, 54″, and a transfer pivot 56′, 56″ consisting of two symmetrically arranged half-disks is pivotably mounted in the same housing 54′, 54″. The piston 52 is biased against the housing 54′, 54″ by means of a spring 58. The piston 52 further carries an engagement notch 60 slightly larger than a corresponding engagement pin 62 of the transfer pivot 56′. The engagement pin 62 of the transfer pivot is located between a rotation axis thereof and the outer circumference thereof. In operation, a carrier strip is guided to the outer circumference of the transfer pivot 56′, 56″, which carries a first tooth 64 (or pair of teeth; “moving tooth”). Transportation of the carrier strip is accomplished by the alternating action of a first tooth 64 (or pair of teeth) arranged on the circumference of the transfer pivot 56′, 56″, and a second tooth 66 (or pair of teeth) located on the inner side of the housing 54′, 54″ (“blocking tooth”). The piston 52 is in this embodiment operated by an external drive (not shown) attached to a bushing 68 formed eccentrically on the piston 52. When the external drive urges down the piston 52, the housing 54′, 54″ keeping a certain minimum distance to the substrate by means of three spacer knobs 70, the crystal is in turn pressed onto the substrate, and at the same time, the transfer pivot 56′, 56″ is moved backwards (with respect to the transport direction of the carrier strip) and disengaged from the carrier strip (FIG. 5b, “DOWN POSITION”). The carrier strip is blocked from moving backwards by the blocking tooth 66 and, in this embodiment, by an additional blocking tooth 66′. At the end of the last step, the moving tooth 64 (or pair of teeth) will engage with a corresponding notch in the carrier strip (or pair of notches). When the external drive next retracts the piston 52, aided by the spring 58, the engagement notch 60 will move the engagement pin 62 forward, pivoting the transfer pivot 56′, 56″ forward (clockwise in the drawing), in turn dragging the carrier strip into the housing 54′, 54″ as required, i.e. by one pitch. In this process, the blocking tooth or teeth 66, 66′ are disengaged from the carrier strip. Again, the teeth suitably have wedged shapes to readily disengage and re-engage from the notches in the carrier strip. The spacer knobs 70 are displaced from the transfer position towards the one (left) side in order for the device to be movable freely in the direction normal to the paper plane. This allows for supplying a substrate sheet material from the same (left) side, making sure that none of the crystals already supplied can collide with any of the spacer knobs, potentially knocking the crystal off. In this embodiment, the emptied part of the carrier strip is guided upward through the bushing 68 so as not to interfere with the external drive.

Referring to FIGS. 6a through 6f; another mode of operation will be explained, in which an intermediate sheet 65 is used along with an automated apparatus: This apparatus also has a transfer reel 53, and a transfer (or carrier) strip 55 running around it, as shown in FIG. 6a (left side is a side view, right side is a plan view). In this embodiment, the crystals 57 are accommodated in round pockets 59, and are held by an annular groove 61 formed in each of the pockets. The upper face 63 of the crystals 57 carries a melt adhesive. The entire assembly is then pressed (arrow) onto an intermediate sheet 65 fixed on a support 67. To this end, the lower side of the intermediate sheet 65 or the upper surface of the support 67 can be made sticky. The upper side of the intermediate sheet 65 or the lower face of the crystals 57 is sticky as well, so that after contacting, the crystals 57 stick to the intermediate sheet 65 and are released out of their annular grooves 61. No further mechanical means is required to effect this. Naturally, an annular inwardly extended rim of the round pockets would work similarly, and a foil partly covering the upper ends of the pockets would not interfere.

The result is shown in FIG. 6b: The intermediate sheet 65, as still arranged on the support 67, now carries the crystals 57 in an upside-down fashion (i.e., larger face upwards), with the melt adhesive facing away from the intermediate sheet 65, in the predetermined pattern in which they were placed on the intermediate sheet 65 by the automated apparatus using the transfer reel 53. As shown in FIG. 6c, the intermediate sheet 65 is then lifted (arrow) from the support 67 and flipped around

(FIG. 6d). The crystals 57 now facing downward, the intermediate sheet 65 is manually placed on a desired portion of the intended substrate 69. From the intermediate sheet side, heat and optionally pressure (arrows) are then applied, so that the melt adhesive 63 melts and bonds to the substrate 69. After cooling off, the intermediate sheet 65 can be lifted from the crystals 57, which are now placed in their proper orientation (larger face downwards on the substrate 69). As a matter of course, the pattern formed by the crystals on the intermediate sheet 65 is a mirror image of the final pattern of the crystals 57 as it appears on the intended substrate 69.

FIG. 7 shows another transfer strip specifically suitable for, but not limited to use in the above process: In this embodiment, the generally circular pockets 71 have vertical slots 73 cutting through the annular grooves 75 and pocket side walls, leaving tabs 83. There may be two or more of such annular grooves, enabling to accommodate similar crystals in inverted orientation or other crystals having a different thickness, while maintaining a proper protruding height. This transfer strip likewise has registration notches 77 formed in the longitudinal side edges 79. One crystal 81 is indicated. In some variants, the annular groove 75 extends over almost the entire depth of the pocket, or instead of an annular groove, an annular rim 83 is provided on the inner circumference of the end of the through hole. These embodiments allow minute movement of the crystal in the through hole, but also allow some crystal size variation.

FIGS. 7a and 7b are cross-sectional and plan views of the transfer strip shown in FIG. 7; as indicated, the cross section of FIG. 7a is taken along the line A-A in FIG. 7b. Again, the vertical slots 73 are shown as running through the annular grooves 75. The outer dimension of this transfer strip is similar to the one of FIGS. 2a,a. From FIG. 7a, it will become evident that the vertical slots 73 extend almost through the entire depth of the pockets 71, imparting flexibility on the remaining quarter-cylindrical tabs 85. Three or four slots 73 or tabs 85 are usually sufficient. The rim 81 holds the crystals in place until a sufficient force is exerted on the crystals from the far side (in FIG. 7a: left side) to expel them through the rims 83, slightly flaring the tabs 85 in the process.

In summary, an apparatus for transferring decorative rigid bodies from a carrier strip onto a substrate includes a reciprocator adapted for individually bringing the decorative rigid bodies into contact with the substrate, and a tractor mechanism operatively coupled to the reciprocator such that an outward motion of the reciprocator is registered with transportation of the carrier strip such that one of the decorative rigid bodies is brought between the reciprocator and the substrate. The carrier strip has pockets accommodating the decorative rigid bodies, and right and left side rims, the right and/or left side rims having engagement features adapted to receive one or more bosses of the tractor mechanism of the apparatus. A method for transferring the decorative rigid bodies from the carrier strip onto the substrate includes moving a decorative rigid body accommodated by the carrier strip into a transfer position; exerting a mechanical force onto the decorative rigid body so as to expel it from the accommodating carrier strip; bringing the tractor mechanism into engagement with a corresponding feature of the carrier strip; and urging the carrier strip forward by means of the engaged tractor mechanism so as to move a next decorative rigid body accommodated by the carrier strip into the transfer position, wherein the motion of the tractor mechanism is reciprocating.

While the invention has been described with respect to certain exemplary embodiments thereof, it is evident that many alternatives, modifications and variations will be apparent to those skilled in the art. Accordingly, the exemplary embodiments of the invention set forth herein are intended to be illustrative and not limiting in any way. Various changes may be made without departing from the present invention as defined in the following claims.

1-36. (canceled)

37. An apparatus for transferring decorative rigid bodies each having at least one flat side from a carrier strip carrying the decorative rigid bodies onto a substrate, the apparatus comprising:
a first reciprocator adapted for individually bringing the decorative rigid bodies into contact with the substrate; and
a second reciprocator adapted for alternately engaging and disengaging with the carrier strip, said second reciprocator operatively coupled to said first reciprocator such that an outward motion of said first reciprocator is registered with transportation of the carrier strip such that one of the decorative rigid bodies is brought in line with said first reciprocator.

38. The apparatus of claim 37, further comprising a one-sided lever, said first reciprocator and said second reciprocator are coupled by said one-sided lever.

39. The apparatus according to claim 37, further comprising a casing, said first reciprocator is mounted on or in said casing and said casing is reciprocatingly movable as said second reciprocator in a protrusion direction of the decorative rigid bodies from the carrier strip.

40. The apparatus according to claim 39, wherein said casing has a stop extending from the apparatus in the protrusion direction, said stop disposed for blocking a movement of said casing upon contact with the substrate, such that a movement of said first reciprocator continues, resulting in a relative movement of said first reciprocator and said casing.

41. The apparatus according to claim 37, wherein said second reciprocator has at least one boss adapted to engage engagement features of the carrier strip.

42. The apparatus according to claim 37, further comprising an actuator having a bushing mounted eccentrically to one of said first reciprocator and said second reciprocator.

43. The apparatus according to claim 42, wherein said bushing surrounds a part of the carrier strip from which the decorative rigid bodies have been transferred to the substrate.

44. The apparatus according to claim 37, wherein a movement of said first reciprocator is substantially linear.

45. The apparatus according to claim 37, wherein a movement of said second reciprocator is substantially linear.

46. The apparatus according to claim 37, wherein a movement of said second reciprocator is arcuate or part-circular.

47. The apparatus according to claim 37, wherein:
said first reciprocator is selected from the group consisting of a hammer and a plunger; and
said second reciprocator is a tractor mechanism.

48. A carrier strip, comprising:
pockets for accommodating decorative rigid bodies; and
side rims including a right side rim and a left side rim, said right side rim and/or said left side rim having engagement features providing straight edge portions adapted to receive at least one boss.

49. The carrier strip according to claim 48, wherein said engagement features include mutually adjacent protrusions and indentations in at least one of said side rims.

50. The carrier strip according to claim 48, wherein said engagement features include generally U-shaped notches having at least one straight edge outer part and a part-circular edge inner part.

51. The carrier strip according to claim 50, wherein said straight edge outer part is formed perpendicularly to a longitudinal extension direction.

52. The carrier strip according to claim 48, wherein said engagement features are formed by notches each having a depth in a widthwise direction of the carrier strip at least two thirds of a width of said notches in a longitudinal extension direction of the carrier strip.

53. The carrier strip according to claim 52, wherein said notches have a pitch commensurate with, or equal to a pitch of the decorative rigid bodies.

54. The carrier strip according to claim 52, wherein said notches are formed in both of said side rims being longitudinal side rims, and each of said notches on one of said longitudinal side rims is registered with an opposing one of said notches on the other of said longitudinal side rims.

55. The carrier strip according to claim 48, wherein the decorative rigid bodies form an array of decorative rigid bodies each having at least one flat side, the array being periodic in a longitudinal extension, the carrier strip further comprising:
a protection layer laterally surrounding the decorative rigid bodies, said protection layer having apertures formed therein through which the decorative rigid bodies can be forcibly expelled; and
a top layer fixed to said protection layer, at least one of said side rims has registration notches formed therein, each of said registration notches having a depth in a widthwise direction of the carrier strip at least two thirds of a width of said registration notch in a longitudinal extension direction.

56. The carrier strip according to claim 55, wherein said registration notches have a pitch commensurate with, or equal to a pitch of the decorative rigid bodies.

57. The carrier strip according to claim 55, wherein said registration notches are formed in both of said left rim and said right rim being longitudinal rims, and each said registration notches on one of said longitudinal rims is registered with an opposing one of said registration notches on the other of said longitudinal rims.

58. The carrier strip according to claim 55, wherein each of said registration notches has a semicircular inner part and a straight outer part formed perpendicularly to the longitudinal extension direction.

59. The carrier strip according to claim 48, wherein each of said pockets has a pocket rim forming an inwardly extending annulus holding a respective one of the decorative rigid bodies accommodated in a respective one of said pockets.

60. The carrier strip according to claim 48, wherein each of said pockets has a rim with a plurality of slits formed therein.

61. The carrier strip according to claim 60, wherein each of said pockets has a rim with four slits formed therein.

62. A method for transferring decorative rigid bodies from a carrier strip onto a substrate, which comprises the steps of:
moving a decorative rigid body accommodated by the carrier strip into a transfer position;
exerting a force onto the decorative rigid body so as to expel the decorative rigid body from the carrier strip;
bringing an engagement feature of a tractor mechanism into engagement with a corresponding feature of the carrier strip; and
urging the carrier strip forward by means of the tractor mechanism so as to move a next decorative rigid body accommodated by the carrier strip into the transfer position, wherein a motion of the tractor mechanism is reciprocating.

63. The method according to claim 62, wherein the motion of the tractor mechanism is linear.

64. The method according to claim 62, wherein the motion of the tractor mechanism is arcuate or part-circular.

65. The method according to claim 62, which further comprises providing a piston for exerting the force on the decorative rigid body, when the piston moves away from the carrier strip after a transfer has taken place, the tractor mechanism moves the carrier strip forward by one pitch distance, and when the piston moves towards the carrier strip at a beginning of a next transfer, the tractor mechanism moves backwards with the carrier strip being held in position.

66. The method according to claim 65, wherein the tractor mechanism has at least one protrusion formed on a guide member, the protrusion engages with the corresponding feature of the carrier strip when the piston is retracted, forwarding the carrier strip by one pitch distance, and moving with respect to the carrier strip by at least one pitch distance when the piston is actuated.

67. A process of applying decorative rigid bodies accommodated in a carrier strip onto a substrate, which comprises the steps of:
moving a decorative rigid body accommodated by the carrier strip into a transfer position;
exerting a force onto the decorative rigid body so as to expel the decorative rigid body from the carrier strip and accomplishing a transfer of the decorative rigid body by a piston acting upon individual ones of the decorative bodies when in the transfer position;
bringing an engagement feature of a tractor mechanism into engagement with a corresponding feature of the carrier strip; and
urging the carrier strip forward by means of the tractor mechanism so as to move a next decorative rigid body accommodated by the carrier strip into the transfer position, wherein a motion of the tractor mechanism is reciprocating, wherein when the piston moves towards the decorative rigid body, to be transferred next, the carrier strip is held in place, and when the piston is retracted after the transfer has been accomplished, the carrier strip is moved to a position where the piston has access to the decorative rigid body next transferred.

68. The process according to claim 67, which further comprises:
moving the carrier strip by engaging at least one notch formed in the carrier strip with corresponding protrusions formed on a first guide member movable with respect to the piston;
dragging the carrier strip forward by at least one pitch distance by moving the first guide member with respect to the piston;
holding the carrier strip in place by engaging at least one of the notches formed in the carrier strip with corresponding protrusions formed on a second guide member fixed with respect to the piston; and
releasing the protrusions formed on the first guide member from the at least one notch of the carrier strip when the first guide member is returned.

69. The process according to claim 67, which further comprises providing the decorative rigid bodies on their lower sides with a pressure sensitive adhesive, such that when forcing out individual ones or groups of the decorative rigid bodies of the carrier strip, bringing them into contact with the substrate, the decorative rigid bodies adhere to the substrate.

70. The process according to claim 67, which further comprises arranging the decorative rigid bodies with their larger end faces towards the substrate.

71. A process of applying decorative rigid bodies accommodated in an upside-down orientation in a carrier strip onto a substrate, which comprises the steps of:
providing the decorative rigid bodies with a hot-melt adhesive provided on upper sides;
positioning the carrier strip above an intermediate sheet;
forcing out individual ones or groups of the decorative rigid bodies of the carrier strip;
bringing the decorative rigid bodies into contact with the intermediate sheet to adhere to the intermediate sheet and to be released from the carrier strip;
positioning the intermediate sheet with the decorative rigid bodies attached thereto on the substrate; and
applying at least one of heat or pressure to a surface of the intermediate sheet facing away from the substrate in order to melt the hot-melt adhesive, thereby adhering the decorative rigid bodies to the surface of the substrate upon cooling of the hot-melt adhesive.

72. The process according to claim 71, which further comprises providing the intermediate sheet with a tacky surface for attaching the decorative rigid bodies thereto.

73. The process according to claim 71, which further comprises disposing the decorative rigid bodies with their smaller end faces towards the intermediate sheet.
